(19) United States
(12) Patent Application Publication
(10) Pub. No.: US 2010/0114914 A1
(43) Pub. Date: May 6, 2010

(54) Selective Home Page Manager

(75) Inventors: Amir F. Gerges, Seminole, FL (US); Alfred E. Majko, Crystal Lake, IL (US); Juan E. Ojeda, Land O'Lakes, FL (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/261,610

(22) Filed: Oct. 30, 2008

(51) Int. Cl. G06F 17/00; G06F 15/16; G06F 7/06; G06F 17/30

(52) U.S. Cl. 707/751; 715/234; 709/217; 707/E17.108

(57) ABSTRACT

A computer implemented method, apparatus, data processing system, and computer program product are present for displaying a web page. A home page for a browser is selected from historical information collected from prior web page access to form a selected home page. The selected home page is displayed on a display device.

### BACKGROUND OF THE INVENTION

1. Field of the Invention

The present invention relates generally to an improved data processing system and, more specifically, to a method and apparatus for processing data. Still more specifically, the present invention relates to a computer-implemented method, apparatus, and computer program code for managing home pages for a web browser.

2. Description of the Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called Transmission Control Protocol/Internet Protocol (TCP/IP).

The Internet has revolutionized communications and commerce as well as become a source for both information and entertainment. For many users, email is a widely used format to communicate over the Internet. Additionally, the Internet is also used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML).

Documents using HTML are also referred to as web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display web pages and to traverse links to other web pages. Resources, such as web pages, are retrieved by a browser from a website on the World Wide Web or a local area network. The browser includes a graphical user interface that allows the user to display and interact with text, images, videos, music, games, and other information typically located on a web page. Text and images on a web page can contain hyperlinks to other web pages at the same or different websites. Web browsers allow a user to quickly and easily access information provided on many web pages at many websites by traversing these links.

Users may start a browser many times during the course of a day. Each time a browser is started or activated, a default web page is retrieved. A browser allows a user to select and/or enter a universal resource locater (URL) that points to a web page to be used as the default web page. This default web page is also referred to as a home page.

Oftentimes, a user may desire to have a different home page. The home page may be changed by opening the web browser and selecting a bookmark or entering a different universal resource locater to select a new home page for the browser.

Some users may desire to use a different web page as a home page during different times of the day or days of the week. Having to select a new home page is time-consuming and inefficient when a user desires to have different default web pages during the day.

Some browsers allow for multiple default web pages to be selected. These different default web pages are opened in a tabbed window. This type of window in the browser presents tabs that a user may select to see the different default web pages. Depending on the different number of web pages that a user desires to have as a default, this type of presentation of default home pages may be difficult to organize and traverse using tabs. Further, if a user desires to change any of the default web pages, the user is still required to open the browser and enter or select a new home page.

Therefore, it would be advantageous to have an improved computer-implemented method, apparatus, and computer program code to manage home pages for a browser.

### BRIEF SUMMARY OF THE INVENTION

In one advantageous embodiment, a computer implemented method, apparatus, data processing system, and computer program product are present for displaying a web page. A home page for a browser is selected from historical information collected from prior web page access to form a selected home page. The selected home page is displayed on a display device.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating a web page management environment in accordance with an illustrative embodiment;

FIG. 4 is a flowchart of a process for selecting a web page in accordance with an illustrative embodiment;

FIG. 5 is a flowchart of a process for selecting a web page in accordance with an illustrative embodiment; and

FIG. 6 is a flowchart of a process for generating queries in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable media may be utilized. The computer usable or computer readable medium may be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer usable or computer readable medium could even be paper or another suitable medium upon which the program is printed, as the program can be electronically captured via, for instance, optical scanning of the paper or other medium, then compiled, interpreted, or otherwise processed in a suitable manner, if necessary, and stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including, but not limited to, a wireless medium, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process. The instructions that execute on the computer or other programmable apparatus provide processes for implementing the functions/acts specified in the flowchart and/or block diagram block or blocks.

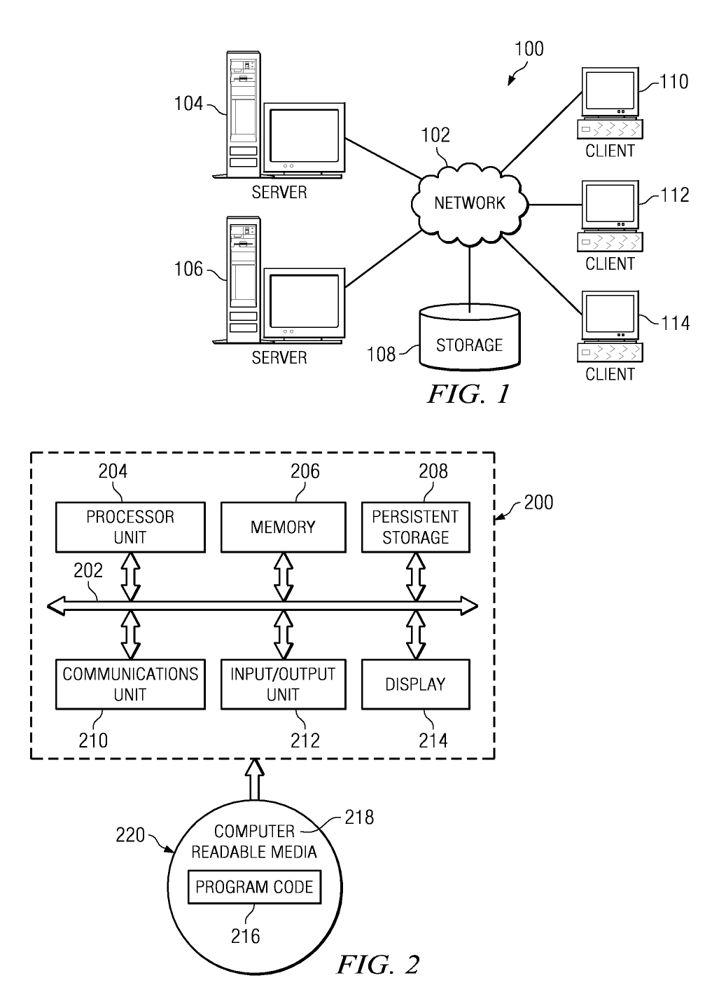

With reference now to the figures and, in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. In the different illustrative embodiments, processes for selecting and/or managing home pages may be implemented in clients 110, 112, and 114. These processes may be used to select a home page based on a history of web page access by users. These processes may select new home pages as the history changes with user access to web pages. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

The different embodiments may be implemented using any hardware device or system capable of executing program code. As one example, the data processing system may include inorganic components integrated with organic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In these examples, data processing system 200 may be implemented in various forms. For example, data processing system 200 may be a computer, a workstation, a laptop computer, a mobile phone, a personal digital assistant, or some other suitable type of data processing system.

The different illustrative embodiments provide a computer-implemented method, apparatus, and computer program code for managing web pages. In particular, the different illustrative embodiments provide a capability to dynamically select home pages for a browser. A home page is selected for the browser from historical information collected from prior web page access to form a selected home page. This selected home page is displayed on a display device.

The different illustrative embodiments also may exchange selected home pages with other browsers. For example, the home page selected for the browser may be sent to another browser for use by another user. This type of selection of the home page for the browser is performed dynamically. In other words, a user does not need to select or enter universal resource locaters for a web page to form the home page for the browser. Instead, a process is employed to select that home page from the historical information collected from prior web page access. This process may be initiated each time a browser is activated. With the different illustrative embodiments, the home page may change over time as the historical information collected from prior web page access changes.

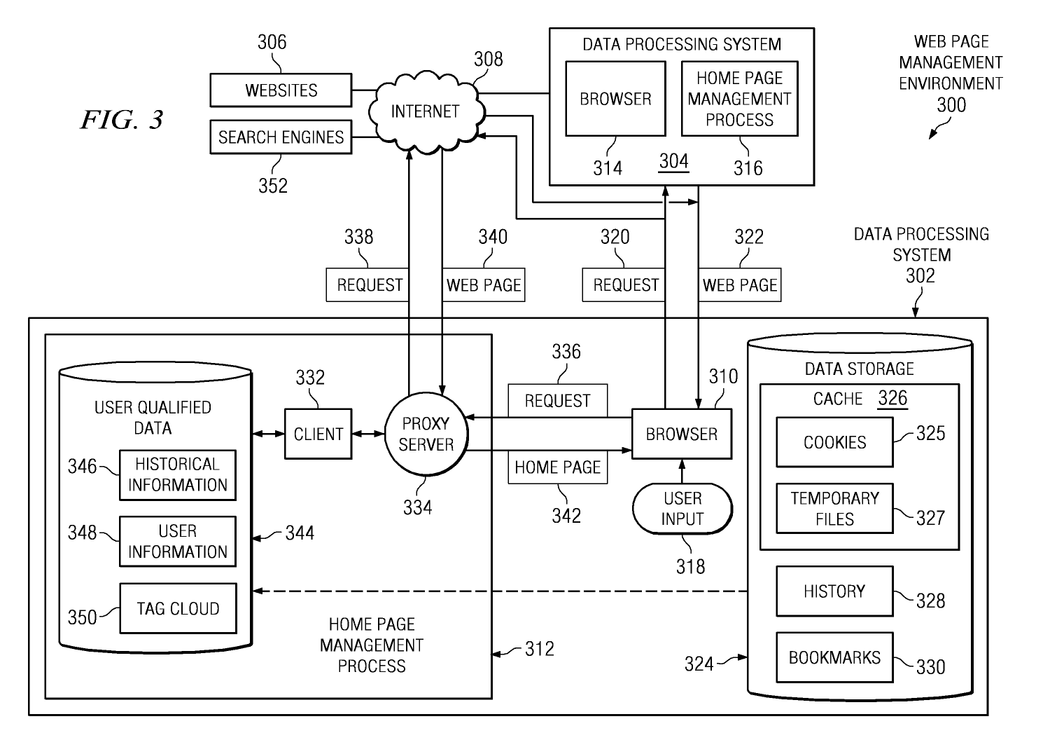

With reference now to FIG. 3, a diagram illustrating a web page management environment is depicted in accordance with an illustrative embodiment. W page management environment 300 is an example of an environment that may be implemented in network data processing system 100 in FIG. 1.

In this illustrative example, data processing system 302 and data processing system 304 may access websites 306 over internet 308. Data processing system 302 and data processing system 304 may be implemented using a data processing system such as, for example, data processing system 200 in FIG. 2. Data processing system 302 and data processing system 304 may take various forms depending on the particular implementation. For example, without limitation, data processing system 302 and/or data processing system 304 may be a desktop computer, a work station, a laptop computer, a personal digital assistant, a mobile phone, an appliance, or some other suitable device. Websites 306 may be hosted on one or more computers such as, for example, server 104 and/or server 106 in FIG. 1.

In this illustrative example, data processing system 302 includes browser 310 and home page management process 312. Data processing system 304 also includes browser 314 and home page management process 316. User input 318 may be received by browser 310 to send request 320 to one of websites 306 to receive web page 322 for presentation to a user.

This activity, as well as interactions with web pages such as web page 322, generate information stored in data storage 324. For example, data storage 324 may contain cache 326, history 328, and bookmarks 330. Cache 326 may contain information such as cookies 325 and temporary files 327. History 328 takes the form of a list of universal resource locators identifying websites visited by user. Bookmarks 330 may be generated by the user for websites of interest as a mechanism to return to those websites at a later time.

In these illustrative examples, home page management process 312 is capable of dynamically generating a home page each time browser 310 is activated. Browser 310 is activated each time the user opens a new browser window.

In this illustrative example, home page management process 312 takes the form of client 332 and proxy server 334. In these illustrative examples, when home page management process 312 is used in conjunction with browser 310, all requests by browser 310 are sent through proxy server 334, rather than having browser 310 directly make requests for information. Proxy server 334 provides interactions with other components such as, for example, browser 310, websites 306, and other suitable processes executing on other data processing systems. In these examples, proxy server 334 acts as a proxy for browser 310 when browser 310 makes requests. Client 332 may include the processes to select a home page for browser 310.

In these illustrative examples, when browser 310 is activated, request 336 is directed to proxy server 334. Request 336 is processed by client 332 to select a home page for browser 310. In this illustrative example, proxy server 334 may send request 338 to retrieve web page 340. W page 340 is the home page selected for browser 310 by proxy server 334. Proxy server 334 sends web page 340 to browser 310 as home page 342.

The selection of web page 340 is made using user qualified data 344 in these illustrative examples. User qualified data 344 includes historical information 346 and user information 348. In some illustrative embodiments, user qualified data 344 may only contain historical information 346. Historical information 346 is historical information collected from prior web page access. In this example, historical information 346 may be obtained from data storage 324. Historical information 346 may include, for example, without limitation, history 328, the contents of cache 326, bookmarks 330, and other information regarding prior web pages accessed by browser 310.

User information 348 may include various preferences by a user. For example, user information 348 may include an identification of a user, a schedule, or other information about a user. Client 332 may use this information along with historical information 346 to select home page 342. Home page 342 may vary over time. As a user visits different websites or has a different pattern of accessing websites, or as other information regarding website access changes, the selection of home page 342 also may change.

For example, if user input 318 is received by browser 310 at 9:00 a.m., client 332 may search historical information 346 to identify websites that may have been visited by user around 9:00 a.m. This website may be, for example, a news website. Client 332 may then select that news website as home page 342 for presentation by browser 310. In another example, if the user has entered work hours in user information 348, client 332 may select a work website as home page 342. Further, if a user is working on a particular project, the user may visit a number of different websites with some level of frequency. Client 332 may identify that set of websites and select a home page from the website with the most visits over a period of time as home page 342.

In yet other advantageous embodiments, user qualified data 344 also may include tag cloud 350. A tag cloud is a visual depiction of user generated tags. In these examples, a tag is a key word or term assigned to a piece of information. In these examples, the word or term is assigned to a particular universal resource locater. Tag cloud 350 may be selected as home page 342. Client 332 updates tag cloud 350. For example, tag cloud 350 may be updated to emphasize or list in order the popularity of websites visited by the user based on historical information 346. These updates also may include adding new websites visited by the user as well as changing the order or emphasis of presentation based on frequency of visits to various websites.

In yet other advantageous embodiments, proxy server 334 also may provide additional services to enrich a browsing experience using browser 310. For example, client 332 may generate a number of requests such as, for example, request 338, to search engines 352. A number of items in these examples refers to one or more items. For example, a number of requests is one or more request. Client 332 may generate these searches based on historical information 346. A search term directed to one search engine, for example, would also be automatically submitted to other search engines by default or by settings in the user qualified data 344.

As an additional feature, home page management process 312 is also capable of providing an interface to perform browser record keeping. This record keeping may include, for example, without limitation, viewing and managing information such as cookies, histories, bookmarks, and other suitable information relating to browser usage. Additional qualifications to the standard data supplied by browser 310 may be provided by the user in user qualified data 344.

Further, home page 342, as generated by client 332, also may be shared with other users in addition to being used by browser 310. For example, proxy server 334 may send home page 342 to home page management process 316 for use as a home page by browser 314 in data processing system 304. In these examples, home page management process 316 is a process similar to home page management process 312. Details of components in this process are not shown to avoid obscuring a description of an illustrative embodiment. Home page management process 316 may send a home page to home page management process 312 for use in selecting a home page for browser 310.

In this manner, home pages may be selected on a dynamic basis without requiring user input to pre-select or define home pages. The illustrative embodiment selects a home page that changes as the historical information collected from prior web page access changes.

The illustration of web page management environment 300 is not meant to imply physical or architectural limitations to the manner in which other environments may be implemented. In other examples, other numbers of data processing systems may be present in addition to or in place of data processing system 302 and data processing system 304. Further, in some illustrative embodiments, home page management process 312 may be implemented as a single process in forms other than proxy server 334 and client 332. For example, home page management process 312 may be implemented within or as part of browser 310 in some illustrative embodiments.

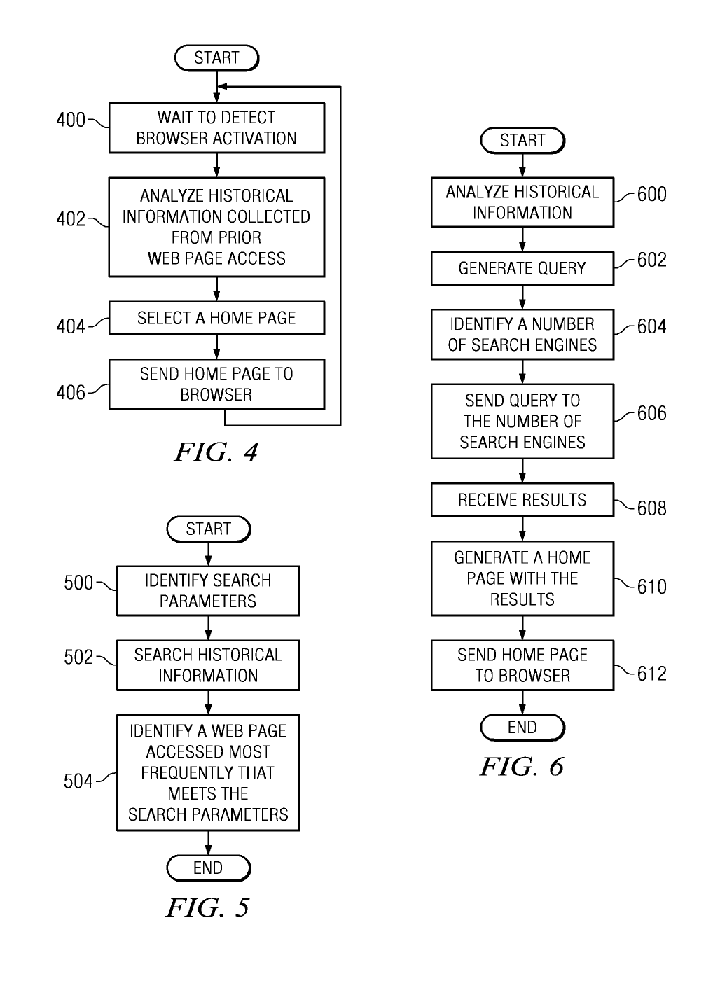

With reference now to FIG. 4, a flowchart of a process for selecting a web page is depicted in accordance with an illustrative embodiment. The process illustrated in FIG. 4 may be implemented using a software component such as, for example, home page management process 312 in FIG. 3.

Home page management process 312 begins by waiting to detect a browser activation (step 400). In these examples, a browser activation is a user input that opens a browser window. In response to detecting a browser activation, home page management process 312 analyzes historical information 346 collected from prior web page access (step 402). Home page management process 312 then selects a home page using this analysis (step 404). The selection of the home page may include retrieving the home page from a website, updating a tag cloud, or performing some other suitable operation to select the home page. Home page management process 312 sends the selected home page to browser 310 for display (step 406), with the process returning to step 400 as described above.

With reference now to FIG. 5, a flowchart of a process for selecting a web page is depicted in accordance with an illustrative embodiment. The process illustrated in FIG. 5 is a more detailed description of step 404 in FIG. 4.

Home page management process 312 identifies search parameters (step 500). These search parameters may be based on user information 348. For example, search parameters may be a schedule for a user, a location of the user, or some other suitable parameter. The history may be searched on terms like frequency of use and subject matter category. Home page management process 312 then searches the historical information using the search parameters (step 502). Home page management process 312 then identifies a web page accessed most frequently that meets the search parameters (step 504), with the process terminating thereafter.

For example, home page management process 312 may identify a web page that has been accessed most frequently during a particular time or period of time. In other examples, the most frequently accessed web page may be a web page from a website for the user's employer if the search parameter is for a work-based web page. In another example, the web page selected may be based on bandwidth capabilities currently present for the data processing system on which the process executes. For example, if the bandwidth is low, the web page selected as a home page may be one that is most frequently accessed that does not contain multi-media content.

With reference now to FIG. 6, a flowchart of a process for generating queries is depicted in accordance with an illustrative embodiment. The process in FIG. 6 may be implemented in a software component, such as home page management process 312 in FIG. 3.

Home page management process 312 begins by analyzing the historical information (step 600). Home page management process 312 generates a query from the analysis (step 602). The query may return results based on default entries of common search engines or by user setup in user qualified data 344.] Home page management process 312 then identifies a number of search engines (step 604). The number of search engines may be identified from a pre-selected list. In other illustrative examples, the number of search engines may be identified based on the analysis. For example, if the query identified is for a publication, then search engines that may identify that type of publication may be selected.

Home page management process 312 then sends the query to the number of search engines (step 606). Home page management process 312 receives results (step 608) and generates a home page with the results (step 610). Home page management process 312 then sends the home page to the browser for presentation (step 612), with the process terminating thereafter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the different illustrative embodiments provide a computer-implemented method, apparatus, and computer program code for managing home page selection as well as providing other services for users of browsers. In the different illustrative embodiments, a home page is selected for a browser from historical information collected from prior web page access to form a selected home page. This selected home page may then be displayed on a display device.

In selecting the home page from the historical information collected from prior web page access, other information also may be used. This information may include at least one of user information, a time at which the browser is activated, a network to which a computer in which the browser is executing is connected to, a time of day, a time of week, an amount of bandwidth available, the type of connection, and other suitable information. As used herein, the phrase “at least one of”, when used with a list of items, means that different combinations of one or more of the items may be used and only one of each item in the list may be needed. For example, “at least one of item A, item B, and item C” may include, for example, without limitation, item A or item A and item B. This example also may include item A, item B, and item C or item B and item C. Further, with the use of a proxy, selected web pages may be sent to other users for use by those users.

The different illustrative embodiments also may automatically submit queries to different search engines based on the history. The selection of historical information collected from prior web page access by another user may be received by the proxy and used to select a web page.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for displaying a web page, the computer implemented method comprising:
selecting a home page for a browser from historical information collected from prior web page access to form a selected home page; and
displaying the selected home page on a display device.

2. The computer implemented method of claim 1, wherein the selecting step comprises:
selecting the home page from the historical of information collected from the prior web page access and at least one of user information, a time at which the browser is activated, a network to which a computer on which the browser is executing is connected, a time of day, a day of week, an amount of bandwidth available, and a type of connection.

3. The computer implemented method of claim 1, wherein the home page comprises a tag cloud and wherein the selecting step comprises:
updating the tag cloud using the historical information collected from the prior web page access.

4. The computer implemented method of claim 1 further comprising:
receiving at least a portion of the historical information from a remote location.

5. The computer implemented method of claim 1 further comprising:
sending at least a portion of the historical information to a remote computer for use in selecting a home page for another browser activated on the remote computer.

6. The computer implemented method of claim 1 further comprising:
submitting a number of queries to a number of search engines using the historical information.

7. The computer implemented method of claim 1 further comprising:
sending the selected home page to another browser located on another computer.

8. The computer implemented method of claim 1, wherein the selecting step is invoked when the browser is activated.

9. The computer implemented method of claim 1, wherein the historical information comprises at least one of a history of universal resource locators visited, a number of cookies, a number of bookmarks, and contents of a browser cache.

10. An apparatus comprising:
historical information collected from prior web page access;
a home page management process capable of selecting a home page for a browser using the historical information collected from the prior web page access; and
a processor unit, wherein the processor unit is capable of executing the home page management process.

11. The apparatus of claim 10, wherein the home page management process is capable of selecting the home page from the historical information collected from the prior web page access and at least one of user information, a time at which the browser is activated, a network to which a computer on which the browser is executing is connected, a time of day, a day of week, an amount of bandwidth available, and a type of connection.

12. The apparatus of claim 10, wherein the home page comprises a tag cloud and wherein the home page management process is capable of updating the tag cloud using the historical information collected from prior web page access.

13. The apparatus of claim 10, wherein the home page management process is capable of receiving at least a portion of the historical information from a remote location.

14. The apparatus of claim 10, wherein the home page management process is capable of sending at least a portion of the historical information to a remote computer for use in selecting a home page for another browser activated on the remote computer.

15. The apparatus of claim 10, wherein the home page management process is capable of submitting a number of queries to a number of search engines using the historical information.

16. The apparatus of claim 10, wherein the home page management process is capable of sending the selected home page to another browser located on another computer.

17. The apparatus of claim 10, wherein the home page management process is capable of selecting the home page each time the web browser is activated.

18. A computer program product for displaying a web page, the computer program product comprising:
a computer recordable storage medium;
program code, stored on the computer recordable storage medium, for selecting a home page for a browser from historical information collected from prior web page access to form a selected home page; and program code, stored on the computer recordable storage medium, for displaying the selected home page on a display device.

19. The computer program product of claim 18, wherein the program code, stored on the computer recordable storage medium, for selecting the home page for the browser from the historical information collected from the prior web page access to form the selected home page further comprises:
program code, stored on the computer recordable storage medium, for selecting the home page from the historical information collected from the prior web page access and at least one of user information, a time at which the browser is activated, a network to which a computer on which the browser is executing is connected, a time of day, a day of week, an amount of bandwidth available, and a type of connection.

20. The computer program product of claim 18, further comprising:
program code, stored on the computer recordable storage medium, for submitting a number of queries to a number of search engines using the historical information.
